(19) United States
(12) Patent Application Publication
(10) Pub. No.: US 2015/0110156 A1
(43) Pub. Date: Apr. 23, 2015

(54) THERMOREFLECTANCE-BASED CHARACTERIZATION OF THERMOELECTRIC MATERIAL PROPERTIES

(71) Applicant: Phononic Devices, Inc., Durham, NC (US)

(72) Inventors: Ian Patrick Wellenius, Raleigh, NC (US); Pablo Cantu, Raleigh, NC (US); Allen L. Gray, Holly Springs, NC (US)

(21) Appl. No.: 14/517,416

(22) Filed: Oct. 17, 2014

Related U.S. Application Data
(60) Provisional application No. 61/894,592, filed on Oct. 23, 2013.

(51) Int. Cl. G01K 11/12; G01K 7/08; G01N 21/17

(52) U.S. Cl. CPC G01K 11/125; G01N 21/1717; G01K 7/08; G01N 2021/1731
USPC 374/161

(57) ABSTRACT

Systems and methods for characterizing one or more properties of a material are disclosed. In some embodiments, the one or more properties include one or more thermal properties of the material, one or more thermoelectric properties of the material, and/or one or more thermomagnetic properties of the material. In some embodiments, a method of characterizing one or more properties of a sample material comprises heating the sample material and, while heating the sample material, obtaining one or more temperature measurements for at least one surface of the sample material via one or more thermoreflectance probes and obtaining one or more electric measurements for the sample material that correspond in time to the one or more temperature measurements. The method further comprises computing one or more parameters that characterize one or more properties of the sample material based on the measurements.

### RELATED APPLICATIONS

This application claims the benefit of provisional patent application Ser. No. 61/894,592, filed Oct. 23, 2013, the disclosure of which is hereby incorporated herein by reference in its entirety.

### FIELD OF THE DISCLOSURE

The present disclosure relates to characterizing properties of a material and, in particular, thermal, thermoelectric, and/or thermomagnetic properties of a material.

### BACKGROUND

A thermoelectric device can be used as a thermoelectric power generator or a thermoelectric cooler. Applications of these devices range from, for example, electronic thermal management and solid state refrigeration to power generation from waste heat sources. A thermoelectric generator is a solid state thermoelectric device that provides direct energy conversion from thermal energy (heat) due to a temperature gradient into electrical energy based on a so-called “Seebeck effect.” Likewise, a thermoelectric cooler is a solid state thermoelectric device that uses the “Peltier effect” to transfer heat from one side of the device to the other with the consumption of electrical energy. The thermoelectric power cycle, with charge carriers (electrons) serving as the working fluid, follows the fundamental laws of thermodynamics and intimately resembles the power cycle of a conventional heat engine. Thermoelectric devices offer several distinct advantages over other technologies including, for example, high reliability, small footprint but with potential scaling to meet large area applications, lightweight, flexibility, and non-position dependency.

Thermoelectric devices and modules are fabricated using a number of different materials. In particular, thermoelectric devices and modules typically include a semiconductor material having good thermoelectric properties as well as contact layers that include one or more metal layers. When designing thermoelectric devices and modules it is oftentimes desirable to characterize materials used in the thermoelectric devices and modules. These materials may be characterized in terms of thermal, thermoelectric, and/or thermomagnetic properties of the materials.

Conventionally, characterization of the thermal, thermoelectric, and/or thermomagnetic properties of a material require contact-based temperature measurements. For example, the use of Alternating Current (AC) measurements of the Seebeck coefficient of a material using thermocouples (see, for example, W. Kubitzki et al., “Application of an AC thermopower measurement to electronic ceramics,” Physica Status Solidi (a), Vol. 56, Issue 2, Dec. 16, 1979, pages 573-579 and J. Martin et al., “High temperature Seebeck coefficient metrology,” Journal of Applied Physics, Vol. 108, 2010, page 121101) and resistance thermometers (see, for example, T. Miao et al., “A self-heating 2ω method for Seebeck coefficient measurement of thermoelectric materials,” Review of Scientific Instruments, Vol. 82, 2011, page 024901) to measure low-frequency temperature oscillations (i.e., contact-based temperature measurements) combined with electronic measurements are known.

While the conventional approaches for characterizing thermal, thermoelectric, and thermomagnetic properties of a material are suitable for large sample material sizes, the conventional approaches are not suitable, or at least are not optimal, for small sample material sizes (e.g., material sizes found in thin-film devices where the thickness of the material is, for example, on the order of 0.1-300 micrometers). As such, there is a need for systems and methods for characterizing the thermal, thermoelectric, and/or thermomagnetic properties of a material that are suitable for small material sizes.

### SUMMARY

Systems and methods for characterizing one or more properties of a material are disclosed. In some embodiments, the one or more properties include one or more thermal properties of the material, one or more thermoelectric properties of the material, and/or one or more thermomagnetic properties of the material. In some embodiments, a method of characterizing one or more properties of a sample material comprises heating the sample material and, while heating the sample material, obtaining one or more temperature measurements for at least one surface of the sample material via one or more thermoreflectance probes and obtaining one or more electric measurements for the sample material that correspond in time to the one or more temperature measurements. The method further comprises computing one or more parameters that characterize one or more properties of the sample material based on the one or more temperature measurements for the at least one surface of the sample material and the one or more electric measurements for the sample material.

In some embodiments, the method further comprises processing the at least one surface of the sample material such that a magnitude of a thermoreflectance coefficient of the sample material with respect to an optical wavelength used by the one or more thermoreflectance probes is increased. In some embodiments, processing the at least one surface of the sample material comprises smoothing the at least one surface. In other embodiments, processing the at least one surface of the sample material comprises applying, on the at least one surface of the sample material, a material having a thermoreflectance coefficient with respect to the optical wavelength used by the one or more thermoreflectance probes having a magnitude that is greater than a magnitude of a thermoreflectance coefficient of the sample material with respect to the optical wavelength used by the one or more thermoreflectance probes.

In some embodiments, the sample material is attached to a substrate such that a first surface of the sample material faces the substrate and a second surface of the sample material faces away from the substrate. The substrate comprises an aperture, and obtaining the one or more temperature measurements comprises focusing one of the one or more thermoreflectance probes onto the second surface of the sample material through the aperture of the substrate.

In other embodiments, the sample material is attached to a substrate such that a first surface of the sample material faces the substrate and a second surface of the sample material faces away from the substrate. The substrate is transparent with respect to the optical wavelength used by the one or more thermoreflectance probes, wherein obtaining the one or more temperature measurements comprises focusing one of the one or more thermoreflectance probes onto the second surface of the sample material through the substrate.

Embodiments of a system for characterizing one or more properties of a sample material are also disclosed. In some embodiments, the system comprises an optical heat pump configured to output first irradiation at a first optical wavelength, a thermoreflectance probe configured to output second irradiation at a second optical wavelength, a first optical subsystem configured to focus the first irradiation output by the optical heat pump and the second irradiation output by the thermoreflectance probe onto a first surface of a sample material, a first thermoreflectance measurement subsystem configured to detect a reflection of the second irradiation from the first surface of the sample material and output a signal indicative of the reflection of the second irradiation from the first surface of the sample material detected by the thermoreflectance measurement subsystem, and electronic probes configured to output one or more signals indicative of one or more electrical parameters for the sample material.

In some embodiments, the system further comprises a processing system configured to obtain one or more temperature measurements for the first surface of the sample material based on the signal output by the first thermoreflectance measurement subsystem indicative of the reflection of the second irradiation from the first surface of the sample material, obtain one or more electric measurements of the one or more electrical parameters for the sample based on the one or more output signals of the electronic probes, and compute one or more parameters that characterize one or more properties of the sample material based on the one or more temperature measurements for the first surface of the sample material and the one or more electric measurements for the sample material.

In some embodiments, the system further comprises a second optical subsystem configured to focus the second irradiation output by the thermoreflectance probe onto a second surface of the sample material, and a second thermoreflectance measurement subsystem configured to detect a reflection of the second irradiation from the second surface of the sample material and output a signal indicative of the reflection of the second irradiation from the second surface of the sample material detected by the second thermoreflectance measurement subsystem.

Further, in some embodiments, the sample material is attached to a substrate such that a first surface of the sample material faces the substrate and a second surface of the sample material faces away from the substrate. The substrate comprises an aperture, wherein the second optical subsystem is configured to focus the second irradiation output by the thermoreflectance probe onto the second surface of the sample material through the aperture in the substrate.

In some embodiments, the system further comprises the sample material, and a material is applied or coated on the first surface of the sample material that has a thermoreflectance coefficient with respect to the optical wavelength used by the thermoreflectance probe having a magnitude that is greater than a magnitude of a thermoreflectance coefficient of the sample material with respect to the optical wavelength used by the thermoreflectance probe.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIGS. 1 and 2 illustrate thermoelectric coefficients for different materials for different wavelengths;

FIG. 3 illustrates a system for characterizing thermal, thermoelectric, and/or thermomagnetic properties of a material according to some embodiments of the present disclosure;

FIG. 4 illustrates an embodiment in which the sample material is attached to a substrate having an aperture through which temperature measurements of the bottom surface of the sample material can be obtained via a thermoreflectance probe;

FIG. 5 illustrates an embodiment in which the sample material is attached to a transparent substrate through which temperature measurements of the bottom surface of the sample material can be obtained via a thermoreflectance probe; and

FIG. 6 is a flow chart that illustrates a process for characterizing thermal, thermoelectric, and/or thermomagnetic properties of a material according to some embodiments of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Systems and methods for characterizing one or more thermal, thermoelectric, and/or thermomagnetic properties of a material are disclosed. In general, the systems and methods disclosed herein utilize a combination of thermoreflectance-based (or more generally any non-contact-based) temperature measurements on at least one surface of a sample material together with electrical and/or magnetic measurements to characterize one or more properties of the sample material. By using thermoreflectance-based temperature measurements (or other non-contact-based temperature measurements), the systems and methods disclosed herein are suitable for small scale sample material sizes, e.g., nanometer or micrometer scale material sizes.

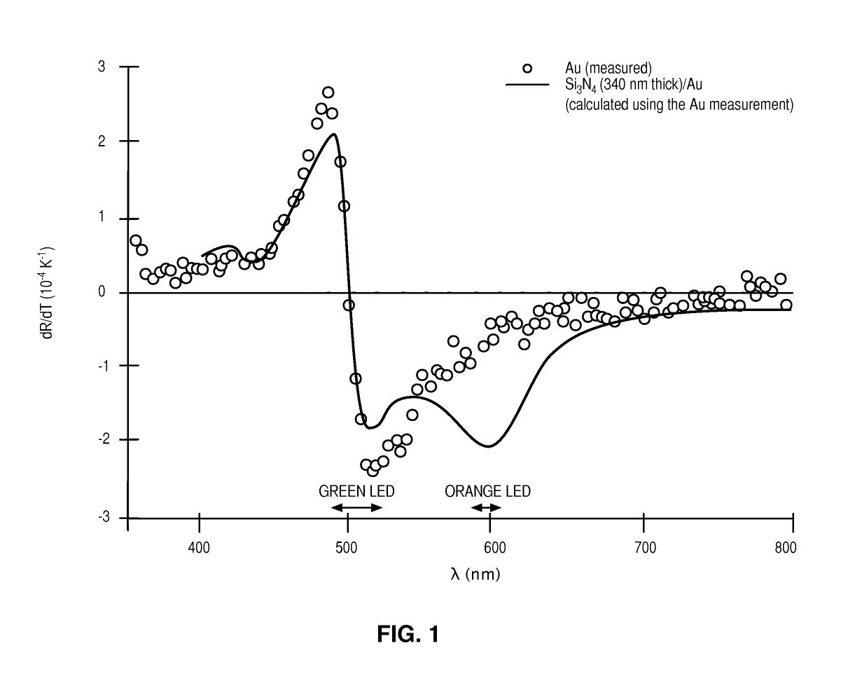

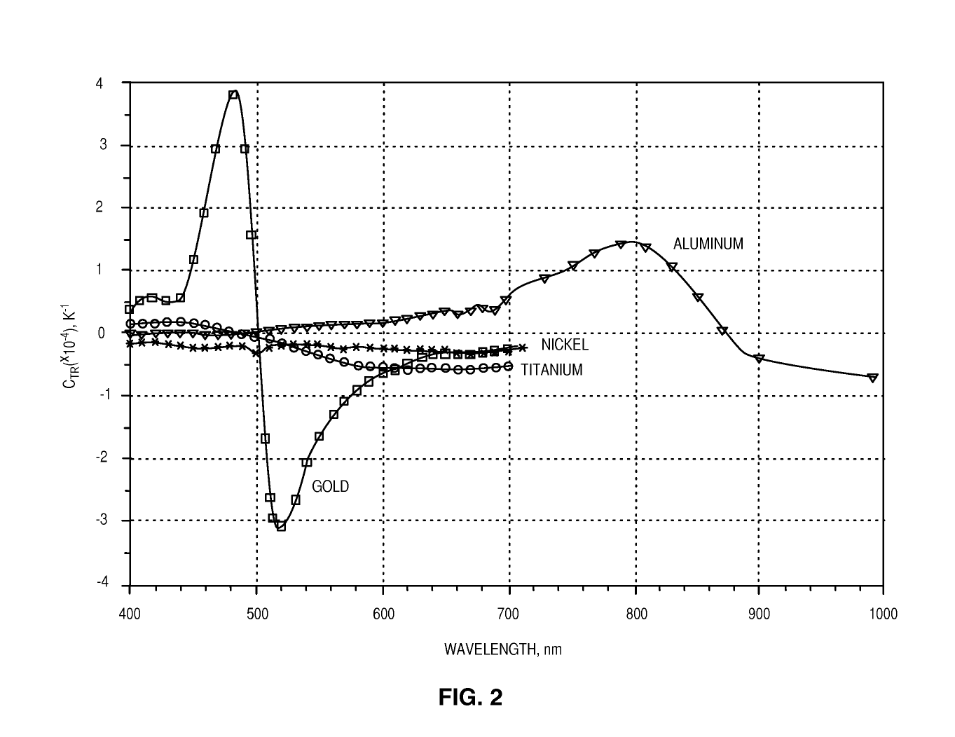

Before proceeding, a discussion of thermoreflectance is beneficial. Thermoreflectance is a property of materials wherein an optical reflectance of a material is a function of the temperature of the material. The thermoreflectance of a material is represented as a Thermoreflectance (TR) coefficient, which is defined as relative change in reflectance per unit temperature change. Thermoreflectance has been demonstrated as a viable technique for detecting very small, periodic changes in temperature of the surface of a material. For example, FIGS. 1 and 2 are figures that correspond to those found in G. Tessier et al., “Quantitative thermal imaging by synchronous thermoreflectance with optimized illumination wavelengths,” Applied Physics Letters, Vol. 78, Issue 16, April 2001, pages 2267-2269 and P. E. Raad, “Thermo-Reflectance Thermography for Submicron Temperature Measurements,” Electronics Cooling, Feb. 1, 2008. As illustrated in FIGS. 1 and 2, the TR coefficient is wavelength and material dependent. As also illustrated, Gold (Au) has a large TR coefficient in the visible wavelength spectrum.

As described below, by selection of the appropriate wavelength for an optical probe (referred to herein as a TR probe) and by heating the surface of a material while also focusing the TR probe onto the surface of the material, the temperature on the surface of the material can be measured by detecting the reflection of the TR probe from the surface of the material. The heating or temperature gradient can be provided by Alternating Current (AC) or Direct Current (DC) heating of the sample. The heating of the sample, or in other words the establishment of a temperature gradient, is required for characterization of thermal, thermoelectric, and/or thermoelectric properties of the material. Using the temperature measurements together with electrical measurements, one or more thermal, thermoelectric, and/or thermomagnetic properties of the material can be characterized.

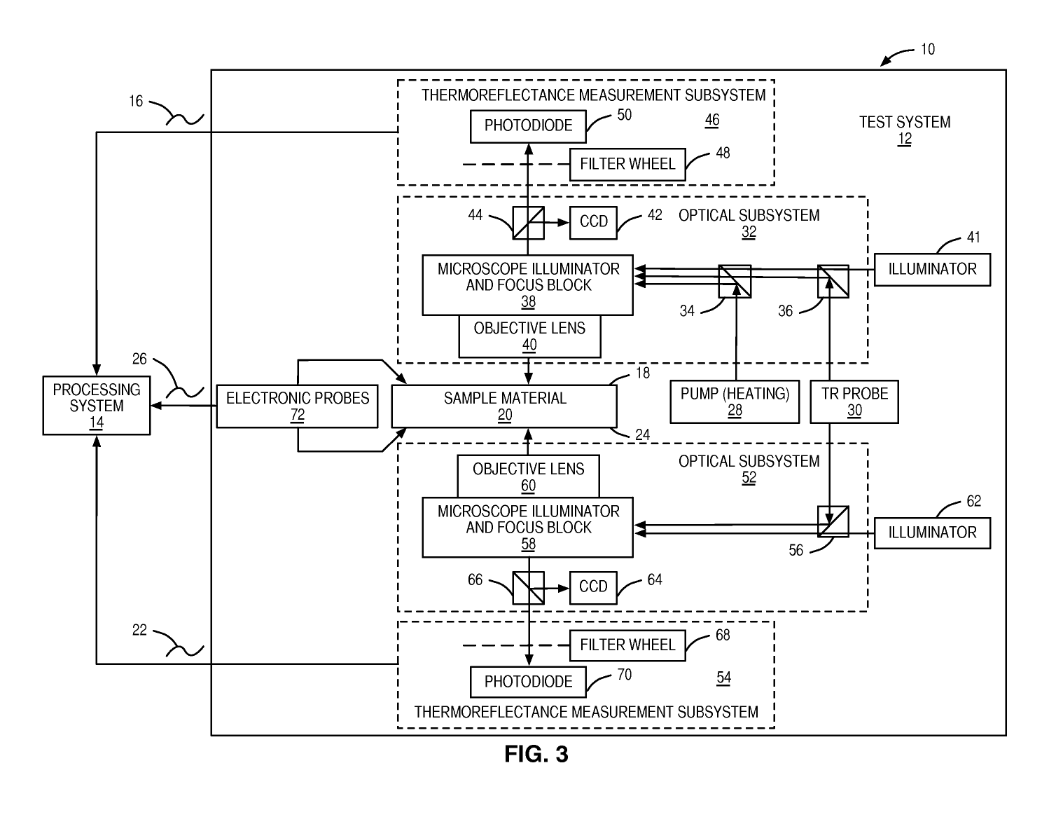

FIG. 3 illustrates a characterization system 10 according to some embodiments of the present disclosure. The characterization system 10 includes a test system 12 and a processing system 14. The test system 12 operates to generate a signal 16 indicative of temperature on a first surface 18 of a sample material 20 and, in some embodiments, a signal 22 indicative of temperature on a second surface 24 of the sample material 20. The signals 16 and 22 are generated using non-contact thermometry. In this particular example, the non-contact thermometry is thermoreflectance-based thermometry. However, other non-contact-based thermometry techniques may be used (e.g., Raman spectroscopy, optical spectroscopy, or the like). In addition, the test system 12 generates one or more signals 26 indicative of, in this example, one or more electronic parameters (e.g., current and/or voltage). The sample material 20 may be any type of material, e.g., a bulk material, a film, a nanostructure (e.g., nanodots, nanowires, nanoribbons, etc.), an integrated circuit, or system.

The processing system 14 is implemented as hardware or a combination of hardware and software. More specifically, the processing system 14 includes one or more processors (e.g., one or more Central Processing Units (CPUs), one or more Application Specific Integrated Circuits (ASICs), one or more Field-Programmable Gate Arrays (FPGAs), or the like, or any combination thereof). In one embodiment, the processing system 14 includes one or more processors that operate to execute software stored in a computer readable medium (e.g., a non-transitory computer readable medium such as, for instance, memory), whereby the processing system 14 is operative to provide the functionality described herein. In operation, the processing system 14 obtains one or more measurements of the temperature on the first surface 18 of the sample material 20 based on the signal 16 and a known relationship between a property of the signal 16 (e.g., relative or absolute magnitude, phase, or frequency) and the temperature on the first surface 18 of the sample material 20. In some embodiments, the processing system 14 obtains one or more measurements of the temperature on the second surface 24 of the sample material 20 based on the signal 22 and a known relationship between a property of the signal 22 (e.g., relative or absolute magnitude, phase, or frequency) and the temperature on the second surface 24 of the sample material 20. The processing system 14 also obtains, in this example, one or more measurements of one or more electrical parameters (e.g., current through the sample material 20 or voltage across the sample material 20) based on the one or more signals 26. Then, based on the temperature measurements and the electrical measurements, the processing system 14 computes one or more parameters that classify one or more thermal, thermoelectric, and/or thermomagnetic properties of the sample material 20. While not illustrated, characterization of thermomagnetic property(ies) (e.g., Nernst coefficient) of the sample material 20 may require a magnetic field near the sample material 20, as will be understood by one of ordinary skill in the art. For example, the processing system 14 may compute a Seebeck coefficient for the sample material 20, a Peltier coefficient for the sample material 20, a Thomson coefficient of the sample material 20, a Lorenz number of the sample material 20 (through the thermal Hall effect), and/or a Nernst coefficient for the sample material 20.

More specifically, in this example, the test system 12 includes a pump 28 that operates to generate an illumination at an optical wavelength that is suitable for heating the sample material 20 (i.e., at an optical wavelength that is substantially absorbed by the sample material 20 or, in some embodiments, an additional material applied to the first and second surfaces 18 and 24 of the sample material 20). In other words, the first and second surfaces 18 and 24 may be coated with this material. The test system 12 also includes a TR probe 30 that operates to generate an illumination at an optical wavelength that is suitable for TR-based temperature measurements for the first and second surfaces 18 and 24 of the sample material 20. This optical wavelength is one at which the TR coefficient of the sample material 20 or, in some embodiments, the TR coefficient of a material applied to the first and second surfaces 18 and 24 of the sample material 20 is greater than or equal to 1×10⁻⁴ K⁻¹, more preferably greater than 1.5×10⁻⁴ K⁻¹, more preferably greater than 2×10⁻⁴ K⁻¹, more preferably greater than 2.5×10⁻⁴ K⁻¹, and even more preferably greater than 3×10⁻⁴ K⁻¹.

An optical subsystem 32 operates to focus the illumination from the pump 28 and the illumination from the TR probe 30 on the first surface 18 of the sample material 20. In this manner, the focused illumination from the pump 28 heats the surface of the sample material 20. Note that, in some embodiments, the area of the surface of the sample material 20 onto which the illumination from the pump 28 is focused has a size (e.g., a dimension such as diameter) that is substantially greater than (e.g., 2×, 3×, or more) a thickness of the sample material 20 to thereby promote one-dimensional (1-D) heat transport through the sample material 20. Conversely, the focused illumination from the TR probe 30 is reflected by the first surface 18 of the sample material 20, where the reflectance of the first surface 18 of the sample material 20, and thus the magnitude and phase of the reflection, is a function of the temperature of the first surface 18 of the sample material 20.

In this example, the optical subsystem 32 includes an optical combiner 34, an optional optical combiner 36, a microscope illuminator and focus block 38, and an objective lens 40. Optionally, the optical combiner 36 combines the illumination from the TR probe 30 and, e.g., white light from an illuminator 41. The illuminator 41 may be beneficial to provide illumination when aligning the objective lens 40 with the sample material 20 (as viewed via a Charge Coupled Device (CCD), Complementary Metal-Oxide Semiconductor (CMOS), or other imaging device 42). The optical combiner 34 combines the illumination from the pump 28 and, in this example, the output of the optical combiner 36. Alternatively, the illumination from the TR probe 30 may be directly input into the optical combiner 34. The combined illumination from the optical combiner 34 is input into the microscope illuminator and focus block 38. The microscope illuminator and focus block 38 together with the objective lens 40 focus the combined illumination onto the first surface 18 of the sample material 20. In this manner, the illumination from the pump 28 and the illumination from the TR probe 30 are simultaneously focused on the first surface 18 of the sample material 20.

Due to the reflectance of the sample material 20, the illumination from the TR probe 30 is reflected by the first surface 18 of the sample material 20 back into the microscope illuminator and focus block 38 via the objective lens 40. This reflection is optionally split by an optical splitter 44 and provided to both the CCD 42 and a TR measurement subsystem 46. Note that the optical splitter 44 and the CCD 42 are optional.

Within the TR measurement subsystem 46, the reflection of the TR probe illumination is filtered by a filter wheel 48 to remove unwanted illumination generated by sources other than the reflected illumination from the TR probe 30, (e.g., the pump 28, the illuminator 41, or other stray light sources). The filtered reflection is then provided to a photodiode 50, which operates to generate the signal 16 as a function of the filtered reflection. Since the reflection is a function of the TR, and thus temperature, of the first surface 18 of the sample material 20, the signal 16 is indicative of the temperature on the first surface 18 of the sample material 20.

In some embodiments, the test system 12 also provides the signal 22 indicative of the temperature on the second surface 24 of the sample material 20. In these embodiments, the test system 12 also includes an optical subsystem 52 that operates to focus the illumination from the TR probe 30 onto the second surface 24 of the sample material 20 and a TR measurement subsystem 54 that operates to generate the signal 22 indicative of the temperature on the second surface 24 of the sample material 20 based on the reflection of the TR probe illumination from the second surface 24 of the sample material 20.

More specifically, in this example, the optical subsystem 52 includes an optional optical combiner 56, a microscope illuminator and focus block 58, and an objective lens 60. Optionally, the optical combiner 56 combines the illumination from the TR probe 30 and, e.g., white light from an illuminator 62. The illuminator 62 may be beneficial to provide illumination when aligning the objective lens 60 with the sample material 20 (as viewed via a CCD 64). Alternatively, the illumination from the TR probe 30 may be directly input into the microscope illuminator and focus block 58. The microscope illuminator and focus block 58 together with the objective lens 60 focus the illumination from the TR probe 30 (or, in some embodiments, the combined illumination from the TR probe 30 and the illuminator 62) on the second surface 24 of the sample material 20.

Due to the reflectance of the sample material 20, the illumination from the TR probe 30 is reflected by the second surface 24 of the sample material 20 back into the microscope illuminator and focus block 58 via the objective lens 60. This reflection is optionally split by an optical splitter 66 and provided to both the CCD 64 and the TR measurement subsystem 54. Note that the optical splitter 66 and the CCD 64 are optional.

Within the TR measurement subsystem 54, the reflection of the TR probe illumination is filtered by a filter wheel 68 to remove unwanted illumination generated by sources other than the reflected illumination from the TR probe 30, (e.g., the illuminator 62 or other stray light sources). The filtered reflection is then provided to a photodiode 70, which operates to generate the signal 22 as a function of the filtered reflection. Since the reflection is a function of the TR, and thus temperature, of the second surface 24 of the sample material 20, the signal 22 is indicative of the temperature on the second surface 24 of the sample material 20.

In some embodiments, the test system 12 also includes electronic probes 72 that operate to generate the one or more signals 26 indicative of one or more electrical parameters, e.g., current and/or voltage. The electronic probes 72 are contact-based, or physical, probes that generate the one or more signals 26 in a conventional manner.

Importantly, depending on the sample material 20, the magnitude of the TR coefficient of the sample material 20 at the wavelength of the illumination output by the TR probe 30 may be less than desired and/or the absorption (and thus heating) of the sample material 20 at the wavelength of the illumination of the pump 28 may be less than desired. Thus, in some embodiments, the first and second surfaces 18 and 24 of the sample material 20 are processed to improve the TR coefficient of the sample material 20 at the wavelength of the illumination output by the TR probe 30 and/or the absorption of the sample material 20 at the wavelength of the illumination of the pump 28.

In some embodiments, the processing of the first and second surfaces 18 and 24 includes applying a material having a TR coefficient at the wavelength of the illumination of the TR probe 30 that has a magnitude that is greater than the magnitude of the TR coefficient of the sample material 20. This material may therefore operate as and be referred to herein as a TR transducer. The magnitude of the TR coefficient of the material applied to the first and second surfaces 18 and 24 of the sample material 20 is preferably at least 1×10⁻⁴ K⁻¹, more preferably at least 1.5×10⁻⁴ K⁻¹, more preferably at least 2×10⁻⁴ K⁻¹, more preferably at least 2.5×10⁻⁴ K⁻¹, and even more preferably at least 3×10⁻⁴ K⁻¹. In addition to having a relatively large magnitude TR coefficient, the material applied to the first and second surfaces 18 and 24 of the sample material 20 preferably has a high thermal conductivity, e.g., at least 1 Wm⁻¹ K⁻¹, more preferably at least 10 Wm⁻¹ K⁻¹, or even more preferably at least 100 Wm⁻¹ K⁻¹. In one particular embodiment, the material applied to the first and second surfaces 18 and 24 of the sample material 20 is Au, and the optical wavelength of the illumination from the TR probe 30 is in the range of and including 505 to 570 nanometers (nm), more preferably in the range of and including 505 to 540 nm, and even more preferably approximately 520 nm. When using Au, the optical wavelength of the TR probe 30 may alternatively be in the range of approximately 450 to 490 nm. In other embodiments, the processing of the first and second surfaces 18 and 24 to improve the TR coefficient includes smoothing the first and second surfaces 18 and 24 (e.g., mechanical or chemical polishing, etching, or annealing).

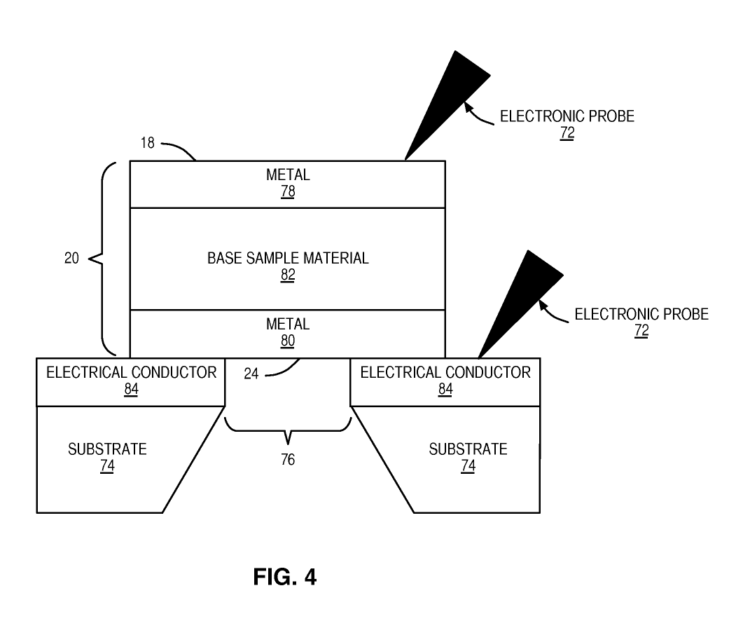

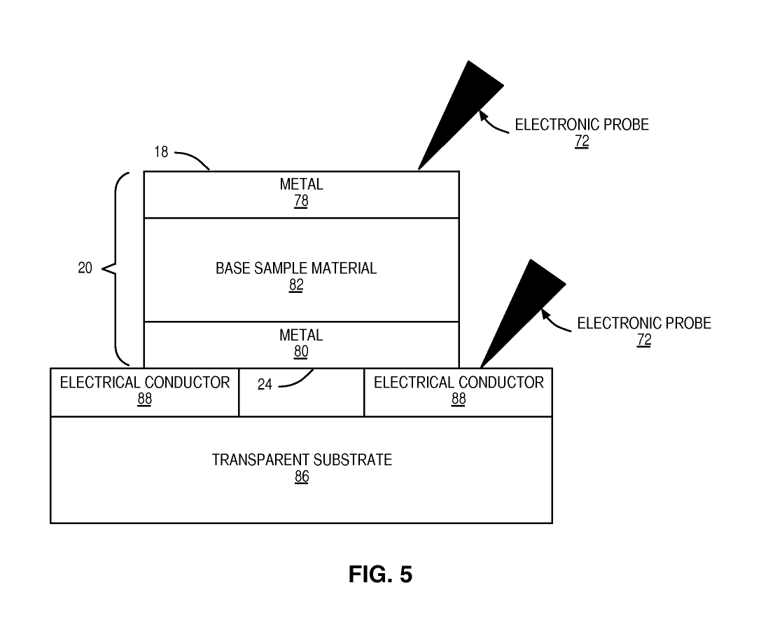

Due to, e.g., the physical size of the sample material 20 in some implementations, in some embodiments, it is desirable to attach the sample material 20 to a substrate. While attaching the sample material 20 to a substrate may assist with, e.g., electric probing, the substrate may prevent TR probing for the second surface 24 of the sample material 20 (i.e., the surface facing the substrate). FIGS. 4 and 5 illustrate embodiments in which the sample material 20 is attached to a substrate that enables TR probing (or other non-contact-based probing) of the temperature of the second surface 24 of the sample material 20 through the substrate. In particular, in the embodiment of FIG. 4, the sample material 20 is attached to a substrate 74 having an aperture 76 through the substrate 74. The aperture 76 exposes a portion of the second surface 24 of the sample material 20. The illumination from the TR probe 30 is focused on the second surface 24 of the sample material 20 through the aperture 76. In this manner, the temperature of the second surface 24 of the sample material 20 can be measured.

In this example, the sample material 20 includes a metal layer 78 forming the first surface 18 of the sample material 20, and a metal layer 80 forming the second surface 24 of the sample material 20. The metal layers 78 or 80, to be effective TR transducers, must be sufficiently thick so as to be opaque to the illumination from the TR probe 30 and illumination from the pump 28, while also being sufficiently thin to not appreciably increase the total thermal resistance of the sample material 20. Here, the preferred range of thicknesses for the metal layer 78 would be 1 nm to 50,000 nm, or more preferably 10 nm to 1,000 nm, or even more preferably 100 nm to 300 nm. Note that the metal layers 78 and 80 may also perform other functions central to material characterization, such as low electrical resistance contact layers or diffusion barriers. The portion of the sample material 20 between the two metal layers 78 and 80 is referred to herein as a base sample material 82. The metal layers 78 and 80 may include one or more layers of the same or different metals or metal alloys. Preferably, the metal layers 78 and 80 are formed of a material or combination of materials having a relatively large magnitude TR coefficient, as discussed above. This enables, or at least improves, the TR-based measurements of the temperature on the first and second surfaces 18 and 24 of the sample material 20. In one embodiment, the metal layers 78 and 80 are Au layers or are at least capped with Au layers.

The surface of the substrate 74 is covered with an electrical conductor 84. Together with the metal layer 78 at the first surface 18 of the sample material 20, the electrical conductor 84 enables the electronic probes 72 to measure or inject, e.g., the current through the sample material 20 and/or measure a voltage across the sample material 20. Note that while two electronic probes 72 are illustrated, additional electronic probes 72 may be used for improved electrical characterization (e.g., separate probes for the injection of current to and measurement of voltage across the sample material 20).

In FIG. 5, the sample material 20 is attached to a transparent substrate 86. The transparent substrate 86 is optically transparent with respect to the wavelength of the illumination from the TR probe 30. As a result, the illumination from the TR probe 30 is focused on the second surface 24 of the sample material 20 through the transparent substrate 86. In this manner, the temperature of the second surface 24 of the sample material 20 can be measured.

In this example, the sample material 20 is the same as that in FIG. 4. The surface of the transparent substrate 86 is covered with an electrical conductor 88. Together with the metal layer 78 at the first surface 18 of the sample material 20, the electrical conductor 88 enables the electronic probes 72 to measure, e.g., the current through the sample material 20 and/or a voltage across the sample material 20.

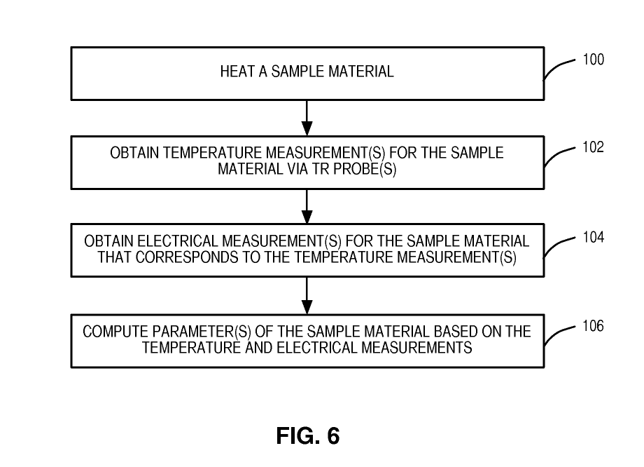

FIG. 6 illustrates a material characterization process according to one embodiment of the present disclosure. The discussion below focuses on an example where the process is performed using the characterization system 10 of FIG. 3. However, this process is not limited to use with the characterization system 10 of FIG. 3. As illustrated, the sample material 20 is heated (step 100). In the characterization system 10, the first surface 18 and/or the second surface 24 of the sample material 20 is heated by focusing optical irradiation from the pump 28 onto the first surface 18 and/or the second surface 24. However, other heating techniques may be used. While heating the sample material 20, one or more temperature measurements for the first surface 18 and/or the second surface 24 of the sample material 20 are obtained via the TR probe 30 and one or more electrical measurements for the sample material 20 that correspond (in time) to the temperature measurement(s) are obtained (steps 102 and 104). Note that while the characterization system 10 of FIG. 3 uses one TR probe 30, multiple TR probes 30 may be used (e.g., a separate TR probe 30 for each of the first and second surfaces 18 and 24). Also, the phrase “correspond in time” as used herein with respect to the temperature and electrical measurements does not mean that each temperature measurement must be perfectly time aligned with a corresponding electrical measurement; rather, measurements that “correspond in time” are to be understood to include measurements that are approximately or closely aligned in time. As discussed above, one or more parameters that quantify one or more properties of the sample material 20 are computed based on the temperature measurement(s) and the electrical measurement(s) (step 106).

The systems and methods disclosed herein have numerous advantages. While not being limited by or to any particular advantage, as an example, the systems and methods disclosed herein can be used to obtain measurements over a broad range of temperatures. Further, the systems and methods disclosed herein can, in some embodiments, be used to characterize anisotropic materials in any specific orientation.

Those skilled in the art will recognize improvements and modifications to the preferred embodiments of the present disclosure. All such improvements and modifications are considered within the scope of the concepts disclosed herein and the claims that follow.

What is claimed is:

1. A method of characterizing one or more properties of a sample material, comprising:
heating a sample material;
while heating the sample material:
obtain one or more temperature measurements for at least one surface of the sample material via one or more thermoreflectance probes; and
obtaining one or more electric measurements for the sample material that correspond in time to the one or more temperature measurements; and
computing one or more parameters that characterize one or more properties of the sample material based on the one or more temperature measurements for the at least one surface of the sample material and the one or more electric measurements for the sample material.

2. The method of claim 1 further comprising processing the at least one surface of the sample material such that a magnitude of a thermoreflectance coefficient of the sample material with respect to an optical wavelength used by the one or more thermoreflectance probes is increased.

3. The method of claim 2 wherein processing the at least one surface of the sample material comprises processing the at least one surface of the sample material such that a magnitude of a thermoreflectance coefficient of the sample material for the at least one surface is at least 1×10⁻⁴ K⁻¹ with respect to the optical wavelength used by the one or more thermoreflectance probes.

4. The method of claim 2 wherein processing the at least one surface of the sample material comprises processing the at least one surface of the sample material such that a magnitude of a thermoreflectance coefficient of the sample material for the at least one surface is at least 2×10⁻⁴ K⁻¹ with respect to the optical wavelength used by the one or more thermoreflectance probes.

5. The method of claim 2 wherein processing the at least one surface of the sample material comprises smoothing the at least one surface.

6. The method of claim 2 wherein processing the at least one surface of the sample material comprises applying, on the at least one surface of the sample material, a material having a thermoreflectance coefficient with respect to the optical wavelength used by the one or more thermoreflectance probes having a magnitude that is greater than a magnitude of a thermoreflectance coefficient of the sample material with respect to the optical wavelength used by the one or more thermoreflectance probes.

7. The method of claim 6 wherein a magnitude of the thermoreflectance coefficient of the material applied on the at least one surface of the sample material with respect to the optical wavelength used by the one or more thermoreflectance probes is at least 1×10⁻⁴ K⁻¹.

8. The method of claim 7 wherein a thermal conductivity of the material applied on the at least one surface of the sample material is at least 1 Wm⁻¹ K⁻¹.

9. The method of claim 6 wherein a magnitude of the thermoreflectance coefficient of the material applied on the at least one surface of the sample material with respect to the optical wavelength used by the one or more thermoreflectance probes is at least 2×10⁻⁴ K⁻¹.

10. The method of claim 9 wherein a thermal conductivity of the material applied on the at least one surface of the sample material is at least 1 Wm⁻¹ K⁻¹.

11. The method of claim 6 wherein the material applied on the at least one surface of the sample material is Gold, and the optical wavelength used by the one or more thermoreflectance probes is in the range of and including 450 to 490 or 505 to 570 nanometers (nm).

12. The method of claim 1 wherein the sample material is attached to a substrate such that a first surface of the sample material faces the substrate and a second surface of the sample material faces away from the substrate, the substrate comprising an aperture, wherein:
obtaining the one or more temperature measurements comprises:
focusing one of the one or more thermoreflectance probes onto the second surface of the sample material through the aperture of the substrate.

13. The method of claim 1 wherein the sample material is attached to a substrate such that a first surface of the sample material faces the substrate and a second surface of the sample material faces away from the substrate, the substrate being transparent with respect to an optical wavelength used by the one or more thermoreflectance probes, wherein:
obtaining the one or more temperature measurements comprises focusing one of the one or more thermoreflectance probes onto the second surface of the sample material through the substrate.

14. The method of claim 1 wherein heating the sample material comprises focusing an optical heat probe onto an area on a surface of the sample material.

15. The method of claim 14 wherein a size of the area onto which the optical heat probe is focused is substantially less than a thickness of the sample material.

16. The method of claim 1 wherein the one or more parameters of the sample material comprise at least one of a group consisting of: one or more parameters that represent one or more thermal properties of the sample material, one or more parameters that represent one or more thermoelectric properties of the sample material, and one or more parameters that represent one or more thermomagnetic properties of the sample material.

17. A system for characterizing one or more properties of a sample material, comprising:
an optical heat pump configured to output first irradiation at a first optical wavelength;
a thermoreflectance probe configured to output second irradiation at a second optical wavelength;
a first optical subsystem configured to focus the first irradiation output by the optical heat pump and the second irradiation output by the thermoreflectance probe onto a first surface of a sample material;
a first thermoreflectance measurement subsystem configured to detect a reflection of the second irradiation from the first surface of the sample material and output a signal indicative of the reflection of the second irradiation from the first surface of the sample material detected by the first thermoreflectance measurement subsystem; and
electronic probes configured to output one or more signals indicative of one or more electrical parameters for the sample material.

18. The system of claim 17 further comprising a processing system configured to:
obtain one or more temperature measurements for the first surface of the sample material based on the signal output by the first thermoreflectance measurement subsystem indicative of the reflection of the second irradiation from the first surface of the sample material;
obtain one or more electric measurements of the one or more electrical parameters for the sample material based on one or more output signals of the electronic probes; and
compute one or more parameters that characterize one or more properties of the sample material based on the one or more temperature measurements for the first surface of the sample material and the one or more electric measurements for the sample material.

19. The system of claim 17 further comprising:
a second optical subsystem configured to focus the second irradiation output by the thermoreflectance probe onto a second surface of the sample material; and
a second thermoreflectance measurement subsystem configured to detect a reflection of the second irradiation from the second surface of the sample material and output a signal indicative of the reflection of the second irradiation from the second surface of the sample material detected by the second thermoreflectance measurement subsystem.

20. The system of claim 19 wherein the sample material is attached to a substrate such that the first surface of the sample material faces the substrate and the second surface of the sample material faces away from the substrate, the substrate comprising an aperture, wherein:
the second optical subsystem is configured to focus the second irradiation output by the thermoreflectance probe onto the second surface of the sample material through the aperture in the substrate.

21. The system of claim 17 wherein:
the system further comprises the sample material; and
a material on the first surface of the sample material has a thermoreflectance coefficient with respect to the second optical wavelength used by the thermoreflectance probe having a magnitude that is greater than a magnitude of a thermoreflectance coefficient of the sample material with respect to the optical wavelength used by the thermoreflectance probe.
